(19) United States
(12) Patent Application Publication
(10) Pub. No.: US 2007/0122120 A1
(43) Pub. Date: May 31, 2007

(54) MULTI-AV STREAM PLAYBACK METHOD AND PLAYBACK APPARATUS

(76) Inventor: Kaoru Ukai, Ome-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/551,489

(22) Filed: Oct. 20, 2006

(30) Foreign Application Priority Data
Nov. 30, 2005 (JP) 2005-345385

(51) Int. Cl. H04N 7/00

(52) U.S. Cl. 386/96

(57) ABSTRACT

According to one embodiment, object data which is formed of a data unit group having time information and includes main AV data and sub AV data is used. Upon synchronously playing back the main AV data and the sub AV data from this object data, time information is acquired from each of the played-back main AV data and sub AV data, and data playback is made using the acquired time information of each of the main AV data and sub AV data.

### CROSS-REFERENCE TO RELATED APPLICATIONS

This application is based upon and claims the benefit of priority from Japanese Patent Application No. 2005-345385, filed Nov. 30, 2005, the entire contents of which are incorporated herein by reference.

### BACKGROUND

1. Field

One embodiment of the invention relates to a multi-AV stream playback method and playback apparatus.

2. Description of the Related Art

In recent years, digitization of audio visual information (AV information) has advanced, and media that record MPEG-encoded AV information are prevalently used. As a typical example of such media, a digital versatile disc (DVD) is known. The standard itself of the DVD has evolved, and the high-definition television compatible next-generation DVD standard called HD_DVD (high definition DVD) will be released soon. In this HD_DVD standard, since the recording density is greatly higher than the current-generation DVD, the playback apparatus side is demanded to have corresponding advanced functions. More specifically, the current-generation DVD-Video standard can play back only one program stream, but the HD_DVD standard has a prerequisite for simultaneous playback of two programs which are independently multiplexed and have no temporal relationship (primary program streams which form a primary video set and secondary program streams which form a secondary video set).

More specifically, an optical disc of the HD_DVD standard records a main video signal, sub-video signal, main audio signal, sub-audio signal, and sub-picture signal as primary program streams, and an optical disc player of the HD_DVD standard is configured to selectively play back these five types of primary program streams.

Also, the player of the HD_DVD standard can acquire a main video signal, sub-video signal, main audio signal, and sub-audio signal as secondary program streams, and is configured to selectively replace the sub-video signal and main audio signal and/or sub-audio signal obtained from the optical disc by those obtained from the server and to synchronously play back the obtained signals.

It is known to synchronously play back different data (video and audio data, or video and sub-picture data) in one program stream (see Jpn. Pat. Appln. KOKAI Publication No. 2004-228627). This patent KOKAI Publication discloses an apparatus which synchronously processes video data and audio data in a special playback mode and normal playback mode. However, this KOKAI Publication has no disclosure about synchronous playback of two program streams (a plurality of independent content: multi-AV streams in a broader sense) which are independently multiplexed and have no temporal relationship.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram for explaining the principal part of a multi-AV stream playback apparatus according to one embodiment of the invention;

FIG. 2 is an exemplary block diagram for explaining an overview of a system (firmware) for executing playback synchronization processing of main data and sub data in the apparatus shown in FIG. 1;

FIG. 3 is an exemplary view for explaining an example of the data structure of multi-AV streams to be played back by the apparatus shown in FIG. 1;

FIG. 4 is an exemplary flowchart for explaining an example (synchronous playback of only I-picture data of main data and sub data) of playback synchronization processing of main data and sub data in the system (firmware) shown in FIG. 2;

FIG. 5 is an exemplary flowchart for explaining another example (synchronous playback using EVOBU_S_PTM included in a navigation pack) of the playback synchronization processing of main data and sub data; and

FIG. 6 is an exemplary flowchart for explaining still another example (synchronous playback using presentation time stamp PTS of I-picture data included in EVOB data) of the playback synchronization processing of main data and sub data.

### DETAILED DESCRIPTION

Various embodiments according to the invention will be described hereinafter with reference to the accompanying drawings. In general, according to one embodiment of the invention, there is provided a method of synchronously playing back main audio video data and sub audio video data from object data which is formed of a data unit group and includes a main video stream, main audio stream, sub video stream, and sub audio stream. With this method, the time information is acquired from each of the played-back main audio video data and the sub audio video data, and data playback is made using the acquired time information of the main audio video data and sub audio video data. In this way, synchronous playback of a plurality of independent content (e.g., main AV data and sub AV data having no temporal mutual relationship) may be implemented.

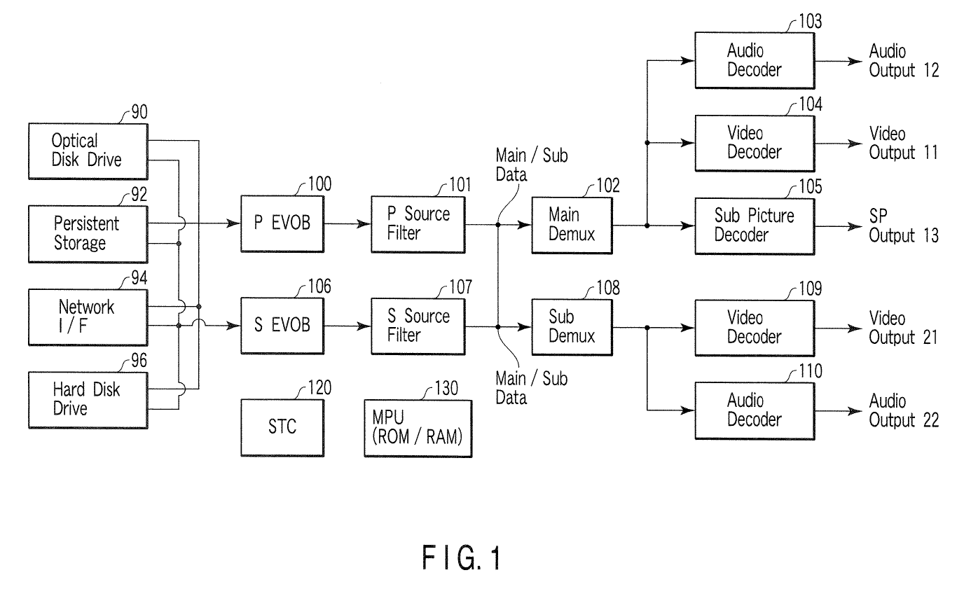

According to an embodiment, FIG. 1 shows a block diagram for explaining principal part of a multi-AV stream playback apparatus (data flow of HD_DVD). This apparatus can extract multi-AV streams compliant to the HD_DVD standard from at least one of Optical Disc Drive 90 using a blue laser or the like, Persistent Storage 92 using a large-capacity flash memory or the like, Network interface 94 configured to connect a contents provider via the Internet or the like, and Hard Disk Drive 96. The operation timing of the overall apparatus shown in FIG. 1 can be determined based on system time clock (STC) 120, and the operation of the overall apparatus is controlled by MPU 130.

Input data to the system configuration of the apparatus shown in FIG. 1 are provided as primary enhanced video object P-EVOB 100 and secondary enhanced video object S-EVOB 106. These data are respectively buffered by Primary Source Filter 101 and Secondary Source Filter 107, and are then supplied to Main Demux 102 and Sub Demux 108. The data separated (demultiplexed) by Main Demux 102 and Sub Demux 108 are respectively sent to and decoded by Main Decoders 103 to 105 and Sub Decoders 109 and 110. Note that main data in the P-EVOB is sent to Main Demux 102, and sub data is sent to Sub Demux 108. Likewise, main data in the S-EVOB is sent to Main Demux 102, and sub data is sent to Sub Demux 108.

Of Main Decoders 103 to 105 and Sub Decoders 109 and 110, the video decoders (104, 109) decode video information encoded by methods such as MPEG2, MPEG4, VC-1, and the like. The audio decoders (103, 110) decode audio information encoded by methods such as AC-3(R), DTS(R), L-PCM, and the like in addition to MPEG. Furthermore, the sub-picture decoder (105) decodes bitmap information encoded by a method (runlength compression using special codes) specified by the HD_DVD standard.

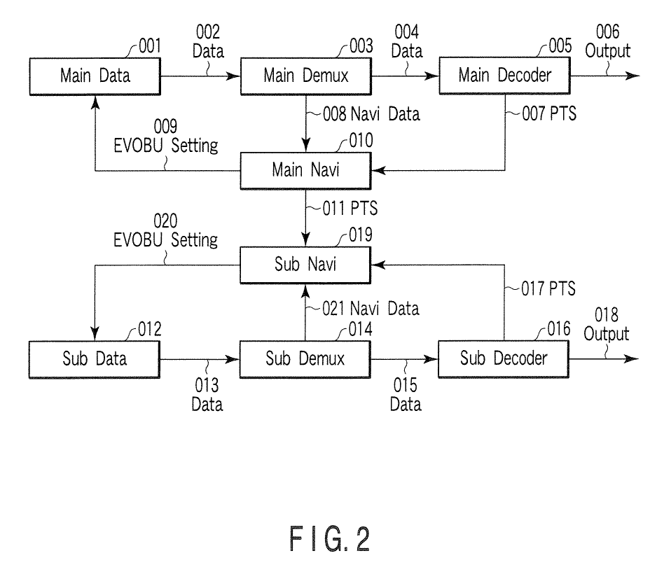

FIG. 2 is a block diagram for explaining an overview of a system (firmware) for executing playback synchronization processing (an example of fastforward play control) of main data and sub data in the apparatus shown in FIG. 1. In the system shown in FIGS. 1 and 2, when normal play is to be made, synchronous playback is guaranteed since clock data (STC 120) is calculated based on data sent to Main Demux 102 (003 in FIG. 2), and Sub Demux 108 (014 in FIG. 2) checks identical STC 120.

In the playback system shown in FIGS. 1 and 2, in addition to normal play, playback modes such as slow play, play pause, step play, fastforward (FF) play, fastreverse (FR) play, and the like are available. These playback modes include STC controlled states such as normal, slow, pause, step, and the like, and STC non-controlled states (STC free states) such as fastforward, and the like. The STC controlled state is a mode that plays back data with reference to the STC, and the STC non-controlled state is a mode that plays back data without referring to the STC.

In the playback system compliant to the HD-DVD standard, synchronous playback is made even in the STC non-controlled state (STC free state) to synchronize main data and sub data. For example, upon transition from fastforward (STC non-controlled/STC free) to normal play (STC controlled), playback starts with reference to time data (STC 120) generated based on main data again. In this case, when the decode speed of sub data in the FF play mode is higher than main data, since the sub data has passed the playback start time of the main data, playback of the sub data starts by returning to the playback start time of the main data. For this reason, synchronous playback is needed in the fastforward play mode.

FIG. 2 exemplifies a system which attains synchronization in the STC non-controlled (STC free) state. That is, the STC free state includes two modes, i.e., a mode for playing back only I-picture data (MPEG2 or the like) and a mode for playing back reference picture data (MPEG4-AVC or the like). In the mode for playing back only I-picture data, a Navigation (010, 019) requests the data output side (001, 012) to output EVOBU data, and only the EVOBU data is sent to a Demux (003, 014).

When the STC controlled state (normal play, slow, pause, step) transits to the STC non-controlled state (FF, FR), synchronization can be attained by “acquiring PTS data of a decoder which is executing playback of main data, passing that time data to the sub decoder side, and sending an EVOBU including the time data”. In the apparatus configuration for this purpose, a playback control circuit (120, 130 in FIG. 1) has a system clock generator (120) for generating system clocks (STC). The playback state (EVOB data: P-EVOB and S-EVOB) includes a system clock controlled state (normal play, slow, pause, step) in which the playback state is managed based on system clocks (STC), and a system clock non-controlled state (FF, FR) in which the playback state is not managed based on the system clock (STC). When the system clock controlled state transits to the system clock non-controlled state, the playback control circuit (120, 130 in FIG. 1) is configured so that the Main Decoder passes time information (PTS or EVOBU_S_PTM) to the sub decoder to playback information of a data unit (EVOBU) corresponding to the passed time information.

Upon transition from the STC non-controlled state to the STC controlled state, playback is paused, and time data is calculated and set again based on main data, thus attaining synchronization. In the apparatus configuration for this purpose, when the system clock non-controlled state (FF, FR) transits to the system clock controlled state (normal play, slow, pause, step), playback of object data (P-EVOB and S-EVOB) is paused, and the system clock (STC) is set using time information of main AV data.

When the playback state transits from the STC controlled state (pause or the like) to the STC controlled state (normal play or the like), clock data (STC) may be re-calculated to attain synchronization again upon transition.

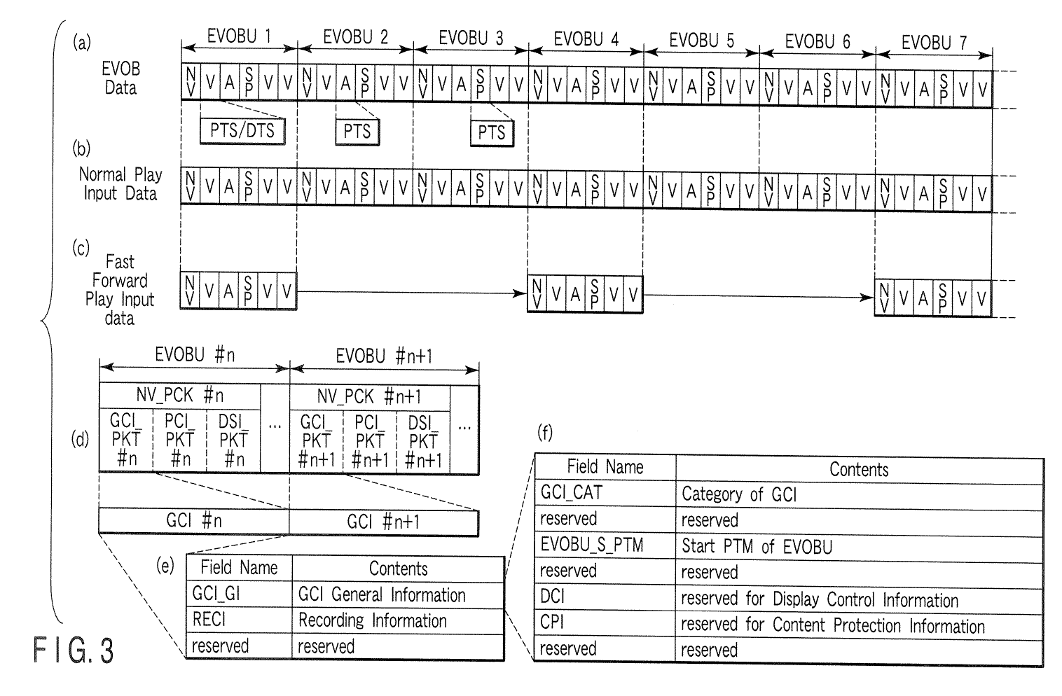

FIG. 3 is a view for explaining an example of the data structure of multi-AV streams to be played back by the apparatus shown in FIG. 1 (the system shown in FIG. 2). Each EVOB includes a plurality of data units (enhanced video object units [EVOBUs]) (FIG. 3(a)). In each EVOBU, navigation pack NV is allocated at the head of the EVOBU, and a predetermined number each of video packs V, audio packs A, and sub-picture packs SP are appropriately allocated after navigation pack NV. Each EVOBU has a size corresponding to the playback time of 0.4 to 1.0 sec (note that the EVOBU at the end of the EVOB has a size corresponding to the playback time of 0.4 to 1.2 sec). Optical Disc Drive 90 in FIG. 1 is configured to access an arbitrary EVOBU from an NV pack at its head position. In the normal play mode, respective EVOBUs are played back in turn (FIG. 3(b)). In the fastforward (FF) play mode, some EVOBUs are played back at intervals (e.g., at a rate of every third EVOBU) (FIG. 3(c)).

Multi-AV streams include a plurality of systems of program streams which are independently multiplexed, and have no temporal relationship. In case of the HD_DVD standard, the multi-AV streams include primary program streams which form a primary video set, and secondary program streams which form a secondary video set. The primary program streams include a main video stream, main audio streams, sub video stream, sub audio streams, sub-picture streams, and advanced streams. Also, the secondary program streams include a main video stream, main audio stream, sub video stream, and sub audio stream. Each of these streams is completed within one object (enhanced video object [EVOB]).

In the case of both the primary video set and secondary video set, the main and sub video streams are stored in video pack V, and the main and sub audio streams are stored in audio pack A. Likewise, the sub-picture streams are stored in sub-picture pack SP. Video pack V has a header including presentation time stamp PTS and decode time stamp DTS. Audio pack A has a header including presentation time stamp PTS. Also, sub-picture pack SP has a header including presentation time stamp PTS.

Navigation pack NV (NV_PCK#n in FIG. 3(d)) allocated at the head of each EVOBU records general control information GCI, which has its general information GCI_GI (FIG. 3(e)). This GCI_GI includes information EVOBU_S_PTM indicating the playback start time of the EVOBU which has at its head position the NV pack that includes the GCI_GI, display control information DCI, content protection information (copy control information) CPI, and the like (FIG. 3(f)).

Playback time information (EVOBU_S_PTM) in the GCI can be used to attain synchronous playback of information (P-EVOB) of the primary video set and that (S-EVOB) of the secondary video set. Also, playback time information (PTS) in packs (V packs and A packs) which store the main and sub video streams, and main and sub audio streams can be used to attain synchronous playback of these streams (that of I-picture data or the like).

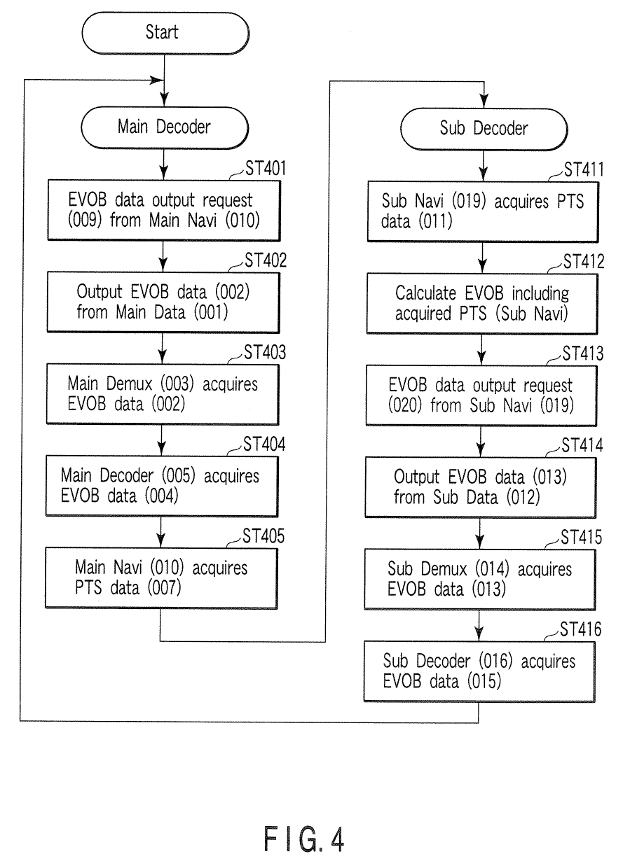

FIG. 4 is a flowchart for explaining an example (synchronous playback of only I-picture data of main data and sub data) of playback synchronization processing of main data and sub data in the system (firmware) shown in FIG. 2. This processing can be written as firmware in a ROM equipped in MPU 130 in FIG. 1. FIG. 4 exemplifies a method of synchronously playing back data while synchronizing the sub decoder and Main Decoder. FIG. 4 will be explained below with reference to the system configuration in FIG. 2.

A Main Navi (010) sets needed EVOB data in Main Data (001) (block ST401), and a Main Demux (003) outputs the set data to a Main Decoder (005) (blocks ST402 to ST404). The Main Navi (010) acquires PTS data output from the Main Decoder (005) (block ST405) and notifies a Sub Navi (019) of that PTS data (block ST411). The Sub Navi (019) calculates an EVOB which includes the acquired PTS data based on that PTS data (blocks ST412 to ST415), and sets that EVOB in the Sub Decoder (016) side (block ST416).

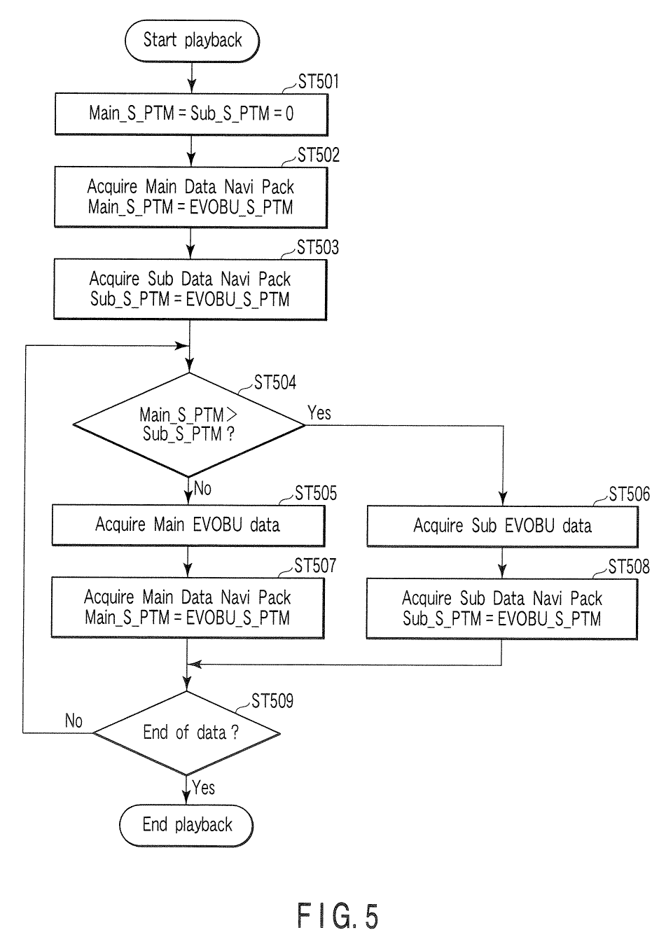

FIG. 5 is a flowchart for explaining another example (synchronous playback using EVOBU_S_PTM included in a navigation pack) of the playback synchronization processing of main data and sub data. This processing can be written as firmware in a ROM equipped in MPU 130 in FIG. 1.

In the system configurations in FIGS. 1 and 2, registers (not shown) of time parameters (Main_S_PTM for Main Data and Sub_S_PTM for Sub Data) in the system are reset to zero (block ST501). After that, Main Demux 102 and/or Sub Demux 108 acquire playback time information (EVOBU_S_PTM) included in navigation packs NV in EVOBUs of Main Data and Sub Data.

The value of the acquired playback time information (EVOBU_S_PTM) of the Main Data is set in the register of time parameter Main_S_PTM (block ST502), and that of the acquired playback time information (EVOBU_S_PTM) of the Sub Data is set in the register of time parameter Sub_S_PTM (block ST503). Note that these time parameter registers can be assured on a part of a RAM area equipped in MPU 130 in FIG. 1.

Next, the value of Main_S_PTM is compared with that of Sub_S_PTM (block ST504). Based on the comparison result, if the playback start time (Main_S_PTM) of the Main Data has already passed at the playback start timing (Sub_S_PTM) of the Sub Data (YES in block ST504), EVOBU data (FIG. 3(a)) of the Sub Data at that timing is acquired (block ST506). Playback time information (EVOBU_S_PTM) in an NV pack of that EVOBU is set in the register of time parameter Sub_S_PTM (block ST508).

On the other hand, if the playback start time (Sub_S_PTM) of the Sub Data has already passed at the playback start timing (Main_S_PTM) of the Main Data (NO in block ST504), EVOBU data (FIG. 3(a)) of the Main Data at that timing is acquired (block ST505). Playback time information (EVOBU_S_PTM) in an NV pack of that EVOBU is set in the register of time parameter Main_S_PTM (block ST507).

The above operations are repeated until input data of the Main Data or Sub Data remain for the P-EVOB and/or S-EVOB (NO in block ST509). During this interval, the Main Data and Sub Data can be played back in sync (synchronous playback) by supplying data to subsequent-stage buffers (decoders) using one of the playback time information of the Main Data and that of the Sub Data (if YES in block ST504, EVOBU_S_PTM=Sub_S_PTM; if NO in block ST504, EVOBU_S_PTM=Main_S_PTM).

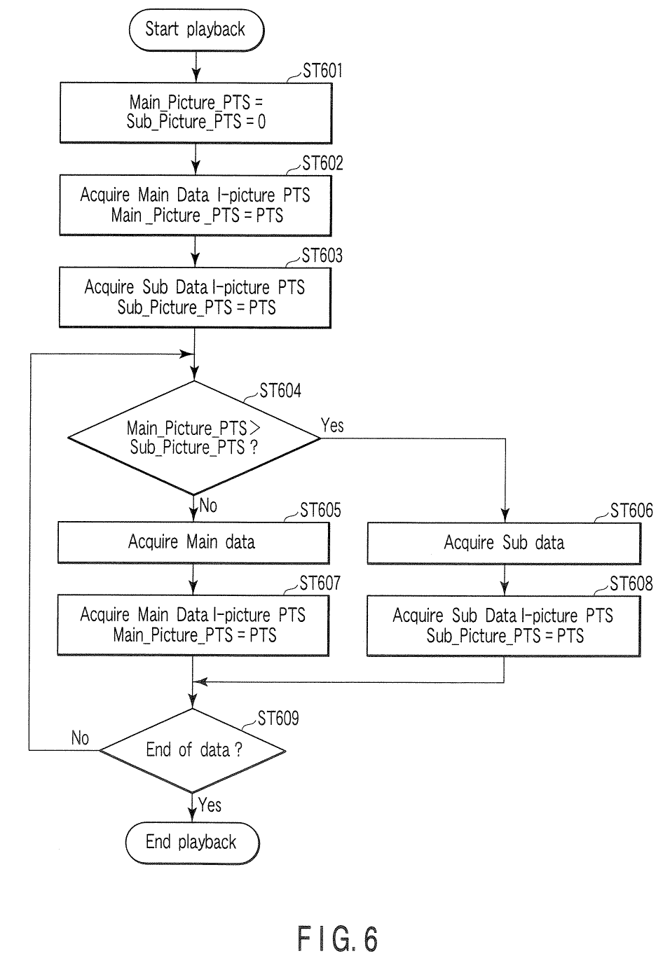

The STC free state includes a mode for playing back only reference picture data and a mode for playing back only I-picture data. In case of I-picture playback (FIG. 6), playback can be made in the same manner as in case of reference picture playback (FIG. 5).

FIG. 6 is a flowchart for explaining still another example (synchronous playback using presentation time stamp PTS of I-picture data included in EVOB data) of the playback synchronization processing of main data and sub data. This processing can be written as firmware in a ROM equipped in MPU 130 in FIG. 1. In this processing, the playback synchronization processing of main data and sub data is implemented using PTS data of I-picture data (in the example of FIG. 3(a), PTS data included in the header of video pack V) in place of EVOB_S_PTM in FIG. 5.

In the system configurations in FIGS. 1 and 2, registers (not shown) of time parameters (Main_Picture_PTS for I-picture data of Main Data and Sub_Picture_PTS for I-picture data of Sub Data) in the system are reset to zero (block ST601). After that, Main Demux 102 and/or Sub Demux 108 acquire playback time information (time stamp PTS) included in video packs V of I-picture data in EVOBUs of Main Data and Sub Data.

The value of the acquired playback time information (PTS) of the Main Data is set in the register of time parameter Main_Picture_PTS (block ST602), and that of the acquired playback time information (PTS) of the Sub Data is set in the register of time parameter Sub_Picture_PTS (block ST603). Note that these time parameter registers can be assured in a part of a RAM area equipped in MPU 130 in FIG. 1.

Next, the value of Main_Picture_PTS is compared with that of Sub_Picture_PTS (block ST604). Based on the comparison result, if the I-picture playback start time (Main_Picture_PTS) of the Main Data has already passed at the I-picture playback start timing (Sub_Picture_PTS) of the Sub Data (YES in block ST604), EVOBU data (FIG. 3(a)) of the Sub Data at that timing is acquired (block ST606). I-picture playback time information (PTS) of that EVOBU is set in the register of time parameter Sub_Picture_PTS (block ST608). Based on the value of this Sub_Picture_PTS, STC 120 in FIG. 1 is set, and the overall playback system performs playback operations under the management of STC 120 in the STC controlled state (normal play mode or the like).

On the other hand, if the I-picture playback start time (Sub_Picture_PTS) of the Sub Data has already passed at the I-picture playback start timing (Main_Picture_PTS) of the Main Data (NO in block ST604), EVOBU data (FIG. 3(a)) of the Main Data at that timing is acquired (block ST605). I-picture playback time information (PTS) of that EVOBU is set in the register of time parameter Main_Picture_PTS (block ST607). Based on the value of this Main_Picture_PTS, STC 120 in FIG. 1 is set, and the overall playback system performs playback operations under the management of STC 120 in the STC controlled state (normal play mode or the like).

The above operations are repeated until input data of the Main Data or Sub Data remain for the P-EVOB and/or S-EVOB (NO in block ST609). During this interval, the Main Data and Sub Data can be played back in sync (synchronous playback) by setting STC 120 using one of the I-picture playback time information of the Main Data and that of the Sub Data (if YES in block ST604, Sub_Picture_PTS=PTS; if NO in block ST604, Main_Picture_PTS=PTS).

### SUMMARY OF EMBODIMENT

<1> In an HD_DVD player, if there are two AV streams, i.e., main and sub streams, they are synchronously played back. In the HD_DVD, a primary EVOB and secondary EVOB are to be played back, and each of these data includes main decoder data and sub decoder data. Data which need be simultaneously played back in stream playback of the primary EVOB (main, sub) and secondary EVOB (main, sub) are one main data and one sub data. Two decoders are used to play back these data. Hence, the filters which separate data are inserted between connections of the primary EVOB file and secondary EVOB file, and the separated data are output to the corresponding main Demux and sub Demux.

<2> In the normal play (normal speed play) mode, synchronization is attained using one clock data generated based on main data so as to control the two streams. However, in the fastforward (FF) or fastreverse (FR) mode, since no clock control is made (STC free), means for synchronizing two streams is needed. (Upon transition from fastforward to normal play, playback starts with reference to clock data generated based on main data again. In this case, when the decode speed of sub data in the FF play mode is higher than main data, since the sub data has passed the playback start time of the main data, playback of the sub data starts by returning to the playback start time of the main data. For this reason, synchronous playback is needed in the fastforward play mode.) Hence, presentation time stamp (PTS) data in the decoder which is executing playback of main data is acquired, that time data is passed to the sub decoder side, and an EVOBU including the time data is sent to the sub decoder, thus synchronizing the main and sub data.

<3> As time stamp data used in synchronization in <2>, EVOBU_S_PTM included in GCI in a navi pack which includes that time data can be used.

<4> As time stamp data used in synchronization in <2>, PTS data of I-picture data in a video pack can be used.

<5> In the normal play mode, an audio gap or the like exists upon connection between EVOBs, and the main side and sub side may be out of synchronization. In such case, synchronization is attained again upon transition of the playback state. When the playback state transits from the STC controlled state (normal play, slow, pause, step, etc.) to the STC controlled state, synchronization is attained again by re-calculating clock data upon transition. When the playback state transits from the STC non-controlled state (STC free state: fastforward, fastreverse, etc.) to the STC controlled state, playback is paused, and synchronization can be attained by calculating and setting clock data based on main data again. When the STC controlled state transits to the STC non-controlled state (STC free state), the method of <2> is applied to attain synchronization. In this way, a system which synchronously outputs two types of content (main and sub) and also synchronously outputs them in the FF or FR mode is novel and useful.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modification as would fall within the scope and spirit of the inventions.

What is claimed is:

1. A method of synchronously playing back main audio video data and sub audio video data from object data which is formed of a group of one or more data units having playback time information and includes the main audio video data and the sub audio video data, comprising:
acquiring the time information from each of the played-back main audio video data and the played-back sub audio video data; and
performing data playback using the acquired time information of each of the main audio video data and the sub audio video data.

2. The method according to claim 1, wherein each of the data units contains a navigation pack at a head position thereof, and the navigation pack includes playback start time information of that data unit, and
when the playback start time information for the main audio video data goes ahead of the playback start time information for the sub audio video data, the playback start time information for the sub audio video data is adopted as the playback time information.

3. The method according to claim 2, wherein when the playback start time information for the main audio video data falls behind the playback start time information for the sub audio video data, the playback start time information for the main audio video data is adopted as the playback time information.

4. The method according to claim 1, wherein each of the data units includes I-picture information having a presentation time stamp as the playback time information, and
when the presentation time stamp for the main audio video data goes ahead of the presentation time stamp for the sub audio video data, the presentation time stamp for the sub audio video data is adopted as the playback time information.

5. The method according to claim 4, wherein when the presentation time stamp for the main audio video data falls behind the presentation time stamp for the sub audio video data, the presentation time stamp for the main audio video data is adopted as the playback time information.

6. A playback apparatus comprising:
an information playback unit configured to play back main audio video data and sub audio video data from object data which is formed of a group of one or more data units having playback time information and includes the main audio video data and the sub audio video data;
a playback control circuit configured to acquire the time information from each of the played-back main audio video data and the sub audio video data, and to make control to perform data playback using the acquired time information of each of the main audio video data and the played-back sub audio video data;
a main decoder configured to decode the played-back main audio video data; and
a sub decoder configured to decode the played-back sub audio video data.

7. The apparatus according to claim 6, wherein each of the data units contains a navigation pack at a head position thereof, and the navigation pack includes playback start time information of that data unit, and
the playback control circuit is configured to adopt, when the playback start time information for the main audio video data goes ahead of the playback start time information for the sub audio video data, the playback start time information for the sub audio video data as the playback time information.

8. The apparatus according to claim 7, wherein the playback control circuit is configured to adopt, when the playback start time information for the main audio video data falls behind the playback start time information for the sub audio video data, the playback start time information for the main audio video data as the playback time information.

9. The apparatus according to claim 6, wherein each of the data units includes I-picture information having a presentation time stamp as the playback time information, and
the playback control circuit is configured to adopt, when the presentation time stamp for the main audio video data goes ahead of the presentation time stamp for the sub audio video data, the presentation time stamp for the sub audio video data as the playback time information.

10. The apparatus according to claim 9, wherein the playback control circuit is configured to adopt, when the presentation time stamp for the main audio video data falls behind the presentation time stamp for the sub audio video data, the presentation time stamp for the main audio video data as the playback time information.

11. The apparatus according to claim 6, wherein the object data includes a primary object and a secondary object which are independently MPEG-encoded, and
the information playback unit is configured to include a filter configured to separate data streams of the primary object and data streams of the secondary object, a main demultiplexer configured to extract information of the main audio video data from the data streams of the primary object and/or the data streams of the secondary object separated by the filter, and a sub demultiplexer configured to extract information of the sub audio video data from the data streams of the primary object and/or the data streams of the secondary object separated by the filter.

12. The apparatus according to claim 6, wherein the playback control circuit comprises a system clock generator configured to generate a system clock, and a playback state of the object data includes a system clock controlled state in which the playback state is managed based on the system clock, and a system clock non-controlled state in which the playback state is not managed based on the system clock, and
the playback control circuit is configured so that, when the system clock controlled state transits to the system clock non-controlled state, the main decoder passes the time information to the sub decoder to perform information playback of the data unit corresponding to the passed time information.

13. The apparatus according to claim 12, wherein when the system clock non-controlled state transits to the system clock controlled state, playback of the object data is paused, and the system clock is set using time information of the main audio video data.
